(19) United States
(12) Patent Application Publication
(10) Pub. No.: US 2020/0040194 A1
(43) Pub. Date: Feb. 6, 2020

(54) UV CURABLE ABRASION RESISTANT COATING

(71) Applicant: AFI Licensing LLC, Lancaster, PA (US)

(72) Inventors: Gary A. SIGEL, Columbia, PA (US); Dong TIAN, Lancaster, PA (US); Daniel P. BAKER, Downingtown, PA (US)

(21) Appl. No.: 16/340,032

(22) PCT Filed: Oct. 4, 2017
(86) PCT No.: PCT/US2017/055089

§ 371 Date: Apr. 5, 2019

(51) Int. Cl. C09D 5/00; B32B 5/16; C08J 7/04; C08K 3/04; E04F 15/12; C09D 4/00

(52) U.S. Cl. CPC C09D 5/00; B32B 5/16; C09D 4/00; C08K 3/04; E04F 15/12; C08J 7/047

(57) ABSTRACT

Abrasion resistant ultraviolet (UV) curable coatings, which may be applied in the field. Flooring products including such abrasion resistant UV curable coatings and methods of applying such abrasion resistant UV curable coatings to flooring products.

### CROSS-REFERENCE TO RELATED APPLICATIONS

This application claims the benefit of U.S. Provisional Application No. 62/404,471, filed Oct. 5, 2017, the contents of which are incorporated herein by reference.

### BACKGROUND OF THE INVENTION

### Field of the Invention

Included are abrasion resistant UV curable coatings, which may optionally be applied in the field. These are particularly useful for installed flooring.

### Summary of Related Art

Current coating compositions for field applied floor wear layer coverings do not provide adequate mar and scratch resistance needed for everyday traffic wear.

### SUMMARY OF THE INVENTION

The present invention is an improved UV curable composition containing micron sized particles which, when cured on a surface, provides improved scratch and mar resistance. “Scratch Resistance” is the ability of a material to resist more severe damage that can lead to visible, deeper or wider trenches. “Mar” and “scratch” refer herein to physical deformations resulting from mechanical or chemical abrasion. “Mar resistance” is a measure of a material's ability to resist appearance degradation caused by small scale mechanical stress. (U.S. Pat. No. 6,835,458.)

In an embodiment of the present invention there is provided a composition including (a) a radiation curable coating composition, such as a floor coating composition; and (b) a pre-mix including abrasion resistant particles and a dispersing agent. In a further embodiment of the present invention the abrasion resistant particles include diamond.

In another embedment of the present invention, the abrasion resistant particles include diamond and at least one other abrasion resistant particle having a Mohs hardness value of at least 6, such as aluminum oxide. In an embodiment of the present invention, the other abrasion resistant particle is present relative to diamond in a weight ratio of about 1:1 to about 10:1.

### DETAILED DESCRIPTION OF THE INVENTION

The coating composition which includes abrasion resistant particles that help impart wear and scratch resistance to the overall coating composition. The improved wear and scratch resistance extends the life span of the floor covering. Examples of the abrasion resistant particles include a combination of abrasion resistant particles, each exhibiting a Mohs hardness value ranging from 6 to 10—including all integers therebetween, as measured on the Mohs scale of mineral hardness. In some embodiments, the abrasion resistant particles may be selected from diamond (Mohs value of 10), aluminum oxide (Mohs value of 9), topaz (Mohs value of 8), quartz (Mohs value of 7), nepheline syenite or feldspar (Mohs value of 6), ceramic or ceramic microspheres (Mohs value of 6), and combinations thereof. The abrasion resistant particle may be a combination of a first abrasion resistant particle consisting of diamond particles and a second abrasion resistant particle having a Mohs value of less than 10. In some embodiments, the coating layer of the present invention may comprise an amount of abrasion resistant particle ranging from about 6 wt. % to about 25 wt. % based on the total weight of the coating layer. In some embodiments, the coating layer of the present invention may comprise an amount of abrasion resistant particle ranging from about 6 wt. % to about 12 wt. % based on the total weight of the coating layer.

According to some embodiments, the second abrasion resistant particle may be present relative to the diamond particle in any suitable weight rating. For example, the weight ratio ranging from about 1:1 to about 10:1. In some non-limiting embodiments, the second abrasion resistant particle is present relative to the diamond particle in a weight ratio of about 1:1. In some non-limiting embodiments, the second abrasion resistant particle is present relative to the diamond particle in a weight ratio of about 2:1. In some non-limiting embodiments, the second abrasion resistant particle is present relative to the diamond particle in a weight ratio of about 4:1. In some non-limiting embodiments, the second abrasion resistant particle is present relative to the diamond particle in a weight ratio of about 8:1. It has been found that coating layers

According to some embodiments, the abrasion resistant particle is a combination of diamond particle and aluminum oxide particles. According to some embodiments, the aluminum oxide particles may have a variety of particle sizes including a mixture of different sized diamond particles. In some non-limiting embodiments, the aluminum oxide particles of the present invention may have an average particle size that is selected from the range of about 2 μm to about 30 μm. In some non-limiting embodiments, the diamond particles of the present invention may have an average particle size that is selected from range of about 2 μm about 100 μm, such as about 5 μm about 50 μm.

In some embodiments, the abrasion resistant particle is a combination of diamond particle and feldspar particles. The feldspar particle may be present relative to the diamond particle in a weight ratio ranging from about 2:1 to about 5:1. In some non-limiting embodiments, the feldspar particle is present relative to the diamond particle in a weight ratio of about 4:1. In some non-limiting embodiments, the feldspar particle is present relative to the diamond particle in a weight ratio of about 2:1. In some non-limiting embodiments, the feldspar particles of the present invention may have an average particle size that is selected from the range of about 2 μm to about 30 μm—including all integers therebetween. It has been found that coating layers comprising a mixture of diamond particles and feldspar particles may exhibit similar abrasion resistance at much lower overall loading levels of abrasion resistant particles compared to coating layers comprising abrasion resistant particles of only feldspar.

According to some embodiments, the diamond particles selected for the coating layer may have a variety of particle sizes including a mixture of different sized diamond particles. However, according to some embodiments, the diamond particles have a narrow size distribution. According to this invention, the term narrow size distribution means a standard deviation that is no more than 35%, preferably less than 35%, of the average particle size for a given diamond particle blend or mixture. In some embodiments, the standard deviation is less than 25% based on the average particle size for a given diamond particle blend or mixture. In some embodiments, the standard deviation is less than 15% based on the average particle size for a given diamond particle blend or mixture.

In some non-limiting embodiments, the micron sized diamond particles of the present invention may have an average particle size that is selected from the range of about 2 μm to about 50 μm, preferably about 4 μm to 35 μm. In some non-limiting embodiments, the diamond particles of the present invention may have an average particle size that is selected from range of about 6 μm about 25 μm.

In some non-limiting embodiments of the present invention, the diamond particles may be a first mixture of diamond particles that has particle sizes ranging from about 6 μm to about 11 μm, preferably from about 6 μm to about 10 μm—including all integers therebetween and mixtures thereof. According to some embodiments, the first mixture of diamond particles may include diamond particles having an average particle size of about 6 μm, about 7 μm, about 8 μm, about 9 μm, about 10 μm, or 11 μm.

Wherein the average particle size is represented at the 50% distribution point (i.e. about 8 μm) and the standard deviation is about 1.7, making the standard deviation about 21% of the average particle size.

It is possible that the first mixture may contain diamond particle having particle sizes outside of the about 6 μm to about 10 μm range so long as the standard deviation for the first mixture is not greater than 35%, preferably less than 35%. In some embodiments, it is possible that the first mixture may contain diamond particle having particle sizes outside of the about 6 mm to about 10 μm range so long as the standard deviation for the first mixture is less than 25%, preferably less than 15%. In some embodiments, the first mixture may contain up to 4 wt. % of diamond particles having a particle size that is less than 6 μm. In some non-limiting embodiments, the first mixture may contain up to 4 wt. % of diamond particles having a particle size that is less than 6 μm. In some embodiments, the first mixture may contain up to 6.54 wt. % of diamond particles having a particle size that is greater than 11 μm.

In some non-limiting embodiments of the present invention, the diamond particles may be a second mixture of diamond particles that has particle sizes ranging from about 15 μm to about 30 μm, preferably about 15 μm to about 25 μm—including all integers therebetween and mixtures thereof. According to some embodiments, the second mixture of diamond particles may have an average particle size of about 15 μm, about 16 μm, about 17 μm, about 18 μm, about 19 μm, about 20 μm, about 21 μm, about 22 μm, about 23 μm, about 24 μm, or about 25 μm.

Alternatively, nano particles of diamond may also be included. Suitable nano particles of diamond have a particle size of about 10 nm to about 500 nm. The nano particle diamond may be included in place of micron sized diamonds or in addition to the micron sized diamond particles

The coating layer including the abrasion resistant particles may include the first abrasion resistant diamond particles in amount that ranges from about 1 wt. % to about 5 wt. %, a based on the total weight of the coating layer, preferably 2 wt. % to 4 wt. %. In some embodiments, the coating layer may comprise about 1.75 wt. % to about 3.7 wt. % of diamond particles. It has been discovered that the coating layer of the present invention may exhibit the desired scratch resistance and gloss retention properties when using abrasion resistant particles that consist of only diamond particles in the above recited amounts. It has also been found that exceeding micron-sized diamond particle loading amounts of 5.5 wt. %, there may be an undesirable effect to the visual properties of the coating layer. Additional amounts of nano-sized diamond particle may be added up to an additional about 10 wt % with no adverse visual property.

The average coating matrix thickness is the vertical distance measure between the top surface and bottom surface of the coating matrix. According to some embodiments, the average matrix coating thickness TCM may range from about 4 μm to about 40 μm—including all integers therebetween. According to some embodiments, the average matrix coating thickness TCM may range from about 6 μm to about 20 μm—including all integers therebetween. According to some embodiments, the average matrix coating thickness TCM is 6 μm. According to some embodiments, the average matrix coating thickness TCM is 18 μm.

In some embodiments, the coating matrix may further comprise other additives and fillers, such as a surfactant, as pigments, tackifiers, surfactant, fillers such as glass or polymeric bubbles or beads (which may be expanded or unexpanded), hydrophobic or hydrophilic silica, calcium carbonate, glass or synthetic fibers, blowing agents, toughening agents, reinforcing agents, fire retardants, antioxidants, and stabilizers. The additives are added in amounts sufficient to obtain the desired end properties. Suitable surfactants of the present invention include, but are not limited to, fluorinated alkyl esters, polyether modified polydimethylsiloxanes and fluorosurfactants, having the formula RfCH2CH2O(CH2CH2O)xH, wherein Rf=F(CF2CF2)y, x=0 to about 15, and y=1 to about 7. The surfactant may be present in the radiation curable adhesive composition by an amount ranging from about 0.5 wt. % to about 2 wt. %, preferably about 0.8 wt. %.

A wax power may be included to increase hydrophobicity of a coating surfaces. These may include fluoropolymers such as polytetrafluroethylene (PTFE).

In some non-limiting embodiments, the coating layer may be produced according to the following master batch methodology. The coating matrix is comprised of the binder, dispersing agent, photoinitiator, and flatting agent.

The abrasion resistant particles comprise diamond particles and are included in a pre-mix that includes a dispersing agent. The dispersing agents may be selected from acrylic block-copolymers, such as commercially available BYK Disperbyk 2008, Disperbyk 2155, Disperbyk 145 and Disperbyk 185, Lubrizol Solsperse 41000 and Solsperse 71000, and may be present in the coating layer by an amount ranging from 0.1 wt. % to 1 wt. %. The abrasion resistant particles may be included in the pre-mix in any appropriate amount to achieve the desired amount of diamond in the final coating.

Commercially available UV coating compositions that may be applied in either the factory or in the field include those available from Allnex under the trade name Macrylnal. These compositions include binders/resins and other additives such as those described below.

Many examples of suitable coating layers are commercially available and well-known in the art. Examples of suppliers that provide suitable compositions include PPG Industries, Sherwin Williams, Akzo Nobel, and Valspar, among others. The abrasion resistant particles may be added to any of these compositions.

In some embodiments are a substrate and an abrasion resistant coating layer. The abrasion resistant coating layer may include coating matrix and abrasion resistant particles. The coating matrix may be a curable coating composition comprising a binder and other additives, such as photoinitiators described below. According to some embodiments, the binder may include acrylate-functional compounds and the abrasion resistant particles comprise a mixture of diamond particles (of micron and/or nano-size) and second abrasion resistant particles.

The binder may include resin selected from acrylate-functional polymer, acrylate-functional oligomer, acrylate-functional monomer, and combinations thereof. The acrylate-functional polymer may include polyester acrylate, polyurethane acrylate, polyether acrylate, polysiloxane acrylate, polyolefin acrylate, and combinations thereof.

A suitable polyester acrylate may be a linear or branched polymer having at least one acrylate or (meth)acrylate functional group. In some embodiments, the polyester acrylate has at least 1 to 10 free acrylate groups, (meth)acrylate groups, or a combination thereof.

The polyester acrylate may have an acrylate functionality The polyester acrylate may be the reaction product of polyester polyol and an carboxylic acid functional acrylate compound such as acrylic acid, (meth)acrylic acid, or a combination thereof at a OH:COOH ratio of about 1:1. The polyester polyol may be a polyester diol having two hydroxyl groups present at terminal end of the polyester chain. In some embodiments, the polyester polyol may have a hydroxyl functionality ranging from 3 to 9, wherein the free hydroxyl groups are present at the terminal ends of the polyester chain or along the backbone of the polyester chain.

In non-limiting embodiments, the polyester polyol may be the reaction product of a hydroxyl-functional compound and a carboxylic acid functional compound. The hydroxyl-functional compound is present in a stoichiometric excess to the carboxylic-acid compound. In some embodiments the hydroxyl-functional compound is a polyol, such a diol or a tri-functional or higher polyol (e.g. triol, tetrol, etc.). In some embodiments the polyol may be aromatic, cycloaliphatic, aliphatic, or a combination thereof. In some embodiments the carboxylic acid-functional compound is dicarboxylic acid, a polycarboxylic acid, or a combination thereof. In some embodiments, the dicarboxylic acid and polycarboxylic acid may be aliphatic, cycloaliphatic, aromatic.

A diol may be selected from alkylene glycols, such as ethylene glycol, propylene glycol, diethylene glycol, dipropylene glycol, triethylene glycol, tripropylene glycol, hexylene glycol, polyethylene glycol, polypropylene glycol and neopentyl glycol; hydrogenated bisphenol A; cyclohexanediol; propanediols including 1,2-propanediol, 1,3-propanediol, butyl ethyl propanediol, 2-methyl-1,3-propanediol, and 2-ethyl-2-butyl-1,3-propanediol; butanediols including 1,4-butanediol, 1,3-butanediol, and 2-ethyl-1,4-butanediol; pentanediols including trimethyl pentanediol and 2-methylpentanediol; cyclohexanedimethanol; hexanediols including 1,6-hexanediol; caprolactonediol (for example, the reaction product of epsilon-caprolactone and ethylene glycol); hydroxy-alkylated bisphenols; polyether glycols, for example, poly(oxytetramethylene) glycol. In some embodiments, the tri-functional or higher polyol may be selected from trimethylol propane, pentaerythritol, di-pentaerythritol, trimethylol ethane, trimethylol butane, dimethylol cyclohexane, glycerol and the like.

In some embodiments the dicarboxylic acid may be selected from adipic acid, azelaic acid, sebacic acid, succinic acid, glutaric acid, decanoic diacid, dodecanoic diacid, phthalic acid, isophthalic acid, 5-tert-butylisophthalic acid, tetrahydrophthalic acid, terephthalic acid, hexahydrophthalic acid, methylhexahydrophthalic acid, dimethyl terephthalate, 2,5-furandicarboxylic acid, 2,3-furandicarboxylic acid, 2,4-furandicarboxylic acid, 3,4-furandicarboxylic acid, 2,3,5-furantricarboxylic acid, 2,3,4,5-furantetracarboxylic acid, cyclohexane dicarboxylic acid, chlorendic anhydride, 1,3-cyclohexane dicarboxylic acid, 1,4-cyclohexane dicarboxylic acid, and anhydrides thereof, and mixtures thereof. In some embodiments the polycarboxylic acid may be selected from trimellitic acid and anhydrides thereof.

In some embodiments, the acrylate-functional polyurethane may be a linear or branched polymer having at least one functional group selected from an acrylate group or a (meth)acrylate group. In some embodiments, the acrylate-functional polyurethane may have at least 2 to 9 functional groups selected from an acrylate group, a (meth)acrylate group, or a combination thereof. In some embodiments, the acrylate-functional polyurethane has between 2 and 4 functional groups selected from an acrylate group, (meth)acrylate group, or a combination thereof.

In some embodiments, the acrylate functional polyurethane may be the reaction product of a high molecular weight polyol and diisocyanate, polyisocyanate, or a combination thereof. The high molecular weight polyol may be selected from polyester polyol, polyether polyol, polyolefin polyol, and a combination thereof—the high molecular weight polyol having a hydroxyl functionality ranging from 3 to 9.

In some embodiments, the polyester polyol used to create the acrylate-functional polyurethane is the same as used to create the acrylate functional polyester. In some embodiments, the polyether polyol may be selected from polyethylene oxide, polypropylene oxide, polytetrahydrofuran, and mixtures and copolymers thereof.

A high molecular weight polyol may be reacted with polyisocyanate, such as a diisocyanate, a tri-functional isocyanate (e.g. isocyanurate), higher functional polyisocyanates, or a combination thereof in an NCO:OH ratio ranging from about 2:1 to 4:1. The polyisocyanate may be selected from isophorone diisocyanate, 4,4′-dicyclohexylmethane-diisocyanate, and trimethyl-hexamethylene-diisocyanate, 1,6 hexamethylene diisocyanate, 2,2,4-trimethylhexamethylene diisocyanate, octadecylene diisocyanate and 1,4 cyclohexylene diisocyanate, toluene diisocyanate; methylenediphenyl diisocyanate; tetra methylxylene diisocyanate, and isocyanurates, biurets, allophanates thereof, as well as mixtures thereof. The resulting reaction product is an isocyanate-terminated prepolymer.

The isocyanate-terminated prepolymer is then reacted with hydroxyl-functional acrylate compound in an NCO:OH ratio of about 1:1 to yield an acrylate or (meth)acrylate functional polyurethane. The hydroxyl-functional acrylate compounds may include hydroxyethyl acrylate, hydroxyethyl methacrylate, hydroxypropyl acrylate, hydroxypropyl methacrylate, hydroxybutyl acrylate, hydroxybutyl methacrylate, hydroxypentyl acrylate, hydroxypentyl methacrylate, hydroxyhexyl acrylate, hydroxyhexyl methacrylate, aminoethyl acrylate, and aminoethyl methacrylate, and a combination thereof.

According to some embodiments, the binder may include acrylate-functional oligomers that include mono-functional oligomers, di-functional oligomers, tri-functional oligomers, tetra-functional oligomers, penta-functional oligomers, and combinations thereof.

Mono-functional oligomers may be selected from alkoxylated tetrahydrofurfuryl acrylate; alkoxylated tetrahydrofurfuryl methylacrylate; alkoxylated tetrahydrofurfuryl ethylacrylate; alkoxylated phenol acrylate; alkoxylated phenol methylacrylate; alkoxylated phenol ethylacrylate; alkoxylated nonylphenol acrylate; alkoxylated nonylphenol methylacrylate; alkoxylated nonylphenol ethylacrylate, and mixtures thereof. The alkoxylation may be performed using ethylene oxide, propylene oxide, butylene oxide, or mixtures thereof. In some embodiments the degree of alkoxylation ranges from about 2 to 10. In some embodiments, the degree of alkoxylation ranges from about 4 to 6.

The di-functional oligomers may be selected from ethylene glycol diacrylate, propylene glycol diacrylate, diethylene glycol diacrylate, dipropylene glycol diacrylate, triethylene glycol diacrylate, tripropylene glycol diacrylate, polyethylene glycol diacrylate, polypropylene glycol diacrylate, ethoxylated bisphenol A diacrylate, bisphenol A diglycidyl ether diacrylate, resorcinol diglycidyl ether diacrylate, 1,3-propanediol diacrylate, 1,4-butanediol diacrylate, 1,5-pentanediol diacrylate, 1,6-hexanediol diacrylate, neopentyl glycol diacrylate, cyclohexane dimethanol diacrylate, ethoxylated neopentyl glycol diacrylate, propoxylated neopentyl glycol diacrylate, ethoxylated cyclohexanedimethanol diacrylate, propoxylated cyclohexanedimethanol diacrylate, and mixtures thereof.

Tri-functional oligomers may be selected from trimethylol propane triacrylate, isocyanurate triacrylate, glycerol triacrylate, ethoxylated trimethylolpropane triacrylate, propoxylated trimethylolpropane triacrylate, tris (2-hydroxyethyl) isocyanurate triacrylate, ethoxylated glycerol triacrylate, propoxylated glycerol triacrylate, pentaerythritol triacrylate, melamine triacrylates, and mixtures thereof.

An acrylate-functional monomer may be selected from acrylic acid, methacrylic acid, ethyl acrylic acid, 2-phenoxyethyl acrylate; 2-phenoxyethyl methylacrylate; 2-phenoxyethyl ethylacrylate; tridecryl acrylate; tridecryl methylacrylate; tridecryl ethylacrylate; and mixtures thereof.

Some embodiments may further include acrylate functional monomers selected from alkyl acrylates having up to about 12 carbon atoms in the alkyl segment such as ethyl acrylate, butyl acrylate, 2-ethylhexyl acrylate, amyl acrylate, n-lauryl acrylate, nonyl acrylate, n-octyl acrylate, isooctyl acrylate, isodecyl acrylate, etc.; alkoxyalkyl acrylates such as methoxybutyl acrylate, ethoxyethyl acrylate, ethoxypropyl acrylate, etc.; hydroxyalkyl acrylates such as hydroxyethyl acrylate, hydroxybutyl acrylate, etc.; alkenyl acrylates such as trimethoxyallyloxymethyl acrylate, allyl acrylate, etc.; aralkyl acrylates such as phenoxyethyl acrylate, benzyl acrylate, etc.; cycloalkyl acrylates such as cyclohexyl acrylate, cyclopentyl acrylate, isobornyl acrylate, etc.; aminoalkyl acrylates such as diethylaminoethyl acrylate; cyanoalkyl acrylates such as cyanoethyl acrylate, cyanopropyl acrylate, etc.; carbamoyloxy alkyl acrylates such as 2-carbamoyloxyethyl acrylate, 2-carbamoyl-oxypropyl acrylate, N-methylcarbamoyloxyethyl acrylate, N-ethylcarbamoyloxymethyl acrylate, 2-(N-methylcarbamoyloxy)-ethyl acrylate, 2-(N-ethylcarbamoyloxy)ethyl acrylate, etc.; and the corresponding methacrylates. In some embodiments, the alkyl acrylates having up to about 12 carbon atoms in the alkyl segment may be used as a reactive solvent/diluent in the abrasions resistant coating layer.

The acrylate-functional monomers may include the binder may comprise resin selected from acrylate-functional polymer, acrylate-functional oligomer, acrylate-functional monomer, and combinations thereof.

In some non-limiting embodiments, the acrylate-functional monomer may be selected from acrylic acid, methacrylic acid, ethyl acrylic acid, 2-phenoxyethyl acrylate; 2-phenoxyethyl methylacrylate; 2-phenoxyethyl ethylacrylate; tridecryl acrylate; tridecryl methylacrylate; tridecryl ethylacrylate; and mixtures thereof.

In some embodiments, the acrylate-functional monomer or oligomer is a silicone acrylate. Curable silicone acrylates are known and suitable silicone acrylates are disclosed, for example in U.S. Pat. Nos. 4,528,081, 4,348,454, herein incorporated by reference. Suitable silicone acrylates include silicone acrylates having mono-, di-, and tri-acrylate moieties. Suitable silicone acrylates include, for example, Silcolease® UV RCA 170 and UV Poly 110, available from Blue Star Co. Ltd, China; and Silmer ACR D2, Silmer ACR Di-10, Silmer ACR Di-50 and Silmer ACR Di-100, available from Siltech.

The coating matrix may further include photoinitiator to facilitate UV curing of the curable coating composition. In some non-limiting embodiments, the photoinitiators may include a benzoin compound, an acetophenone compound, an acylphosphine oxide compound, a titanocene compound, a thioxanthone compound or a peroxide compound, or a photosensitizer such as an amine or a quinone. Specific examples photoinitiatiors include 1-hydroxycyclohexyl phenyl ketone, benzoin, benzoin methyl ether, benzoin ethyl ether, benzoin isopropyl ether, benzyl diphenyl sulfide, tetramethylthiuram monosulfide, azobisisobutyronitrile, dibenzyl, diacetyl and beta-chloroanthraquinone. In some embodiments, the photoinitators are water soluble alkylphenone photoinitiators.

The coating matrix may further include an amine synergist. In some embodiments, the amine synergist may include diethylaminoethyle methacrylate, dimethylaminoethyl methacrylate, N—N-bis(2-hydroxyethyl)-P-toluidine, Ethyl-4-dimethylamino benzoate, 2-Ethylhexyl 4-dimethylamino benzoate, as well as commercially available amine synergist, including Sartomer CN 371, CN373, CN383, CN384 and CN386; Allnex Ebecry P104 and Ebecry P115. The amine synergist may be present in the radiation curable coating composition by an amount ranging from about 1 wt. % to about 5 wt. %, preferably about 3 wt. %

The layer which includes abrasion resistant particles that help impart wear and scratch resistance to the overall coating stack. The improved wear and scratch resistance extends the life span of the floor covering. Examples of the abrasion resistant particles include a combination of abrasion resistant particles, each exhibiting a Mohs hardness value ranging from 6 to 10—including all integers therebetween, as measured on the Mohs scale of mineral hardness. In some embodiments, the abrasion resistant particles may be selected from diamond (Mohs value of 10), aluminum oxide (Mohs value of 9), topaz (Mohs value of 8), quartz (Mohs value of 7), nepheline syenite or feldspar (Mohs value of 6), ceramic or ceramic microspheres (Mohs value of 6), and combinations thereof. The abrasion resistant particle may be a combination of a first abrasion resistant particle consisting of diamond particles and a second abrasion resistant particle having a Mohs value of less than 10. In some embodiments, the coating layer of the present invention may comprise an amount of abrasion resistant particle ranging from about 6 wt. % to about 25 wt. % based on the total weight of the coating layer. In some embodiments, the coating layer of the present invention may comprise an amount of abrasion resistant particle ranging from about 6 wt. % to about 12 wt. % based on the total weight of the coating layer.

According to some embodiments, the second abrasion resistant particle may be present relative to the diamond particle in any suitable weight rating. For example, the weight ratio ranging from about 1:1 to about 10:1. In some non-limiting embodiments, the second abrasion resistant particle is present relative to the diamond particle in a weight ratio of about 1:1. In some non-limiting embodiments, the second abrasion resistant particle is present relative to the diamond particle in a weight ratio of about 2:1. In some non-limiting embodiments, the second abrasion resistant particle is present relative to the diamond particle in a weight ratio of about 4:1. In some non-limiting embodiments, the second abrasion resistant particle is present relative to the diamond particle in a weight ratio of about 8:1. It has been found that coating layers comprising a mixture of diamond particles and second abrasion resistant particle of the present invention (e.g., aluminum oxide particles) exhibits similar abrasion resistance at much lower overall loading levels of abrasion resistant particles compared to coating layers comprising abrasion resistant particles of only aluminum oxide.

According to some embodiments, the abrasion resistant particle is a combination of diamond particle and aluminum oxide particles. According to some embodiments, the aluminum oxide particles may have a variety of particle sizes including a mixture of different sized diamond particles. In some non-limiting embodiments, the aluminum oxide particles of the present invention may have an average particle size that is selected from the range of about 2 μm to about 30 μm. In some non-limiting embodiments, the diamond particles of the present invention may have an average particle size that is selected from range of about 2 μm about 100 mm, such as about 5 μm about 50 μm.

In some embodiments, the abrasion resistant particle is a combination of diamond particle and feldspar particles. The feldspar particle may be present relative to the diamond particle in a weight ratio ranging from about 2:1 to about 5:1. In some non-limiting embodiments, the feldspar particle is present relative to the diamond particle in a weight ratio of about 4:1. In some non-limiting embodiments, the feldspar particle is present relative to the diamond particle in a weight ratio of about 2:1. In some non-limiting embodiments, the feldspar particles of the present invention may have an average particle size that is selected from the range of about 2 μm to about 30 μm—including all integers therebetween. It has been found that coating layers comprising a mixture of diamond particles and feldspar particles may exhibit similar abrasion resistance at much lower overall loading levels of abrasion resistant particles compared to coating layers comprising abrasion resistant particles of only feldspar.

According to some embodiments, the diamond particles selected for the coating layer may have a variety of particle sizes including a mixture of different sized diamond particles. However, according to some embodiments, the diamond particles have a narrow size distribution. According to this invention, the term narrow size distribution means a standard deviation that is no more than 35%, preferably less than 35%, of the average particle size for a given diamond particle blend or mixture. In some embodiments, the standard deviation is less than 25% based on the average particle size for a given diamond particle blend or mixture. In some embodiments, the standard deviation is less than 15% based on the average particle size for a given diamond particle blend or mixture.

### Examples

Abrasion Resistance Testing

A biobased tile (BBT) [CONFIRM] was tested for abrasion resistance when coated with various UV cured coatings, including coatings of the present invention including diamond as the abrasive particle. The coatings, procedure, and results are described below.

Procedure:

An industry leading test that simulates wear (BS EN 16094: Laminate Floor Coverings—Test Method for the determination of micro-scratch resistance), which uses a Martindale abrasion tester, was employed as discussed below.

The following parameters were employed using a mini-Martindale tester:

TABLE 1
Abrasion test parameters.

| Test Parameter | Procedure B |
|---|---|
| Scrub Material | Medium Fine |
| | (Scotch-Brite ™ 7440 pad) |
| Holder for Scrub Material | Version 1 (sample holder with |
| | small weight) = 0.84 pounds |
| Speed Factor | 1 |
| Number of Rubs | 160 |
| Assessment | Visual Assessment According |
| | to Annex B |

UV coatings including the abrasive particles shown in Table 2 were coated on biobased tile for in an amount of 20 g/m² and cured using a Field applied machine.

TABLE 2
Abrasive particles used in coatings tested

| | Mean Particle | Weight | Visual Evaluation |
|---|---|---|---|
| | Size | Percent | as per |
| Abrasive Particle | (microns) | in Coating | EN 16094 Method |
| None (Control) | n/a | n/a | B4 |
| Diamond (Inventive) | 6-10 | 4.06 | B2 |
| Diamond (Inventive) | 15-20 | 4.06 | B2 |
| Ceramic Microspheres | 12 | 4.06 | B4 |
| Aluminum Oxide | 12 | 4.06 | B3 |
| Aluminum Oxide | 20 | 4.06 | B3 |

Visual Evaluations were determined using the criteria outlined in Annex B of the EN 16094 test method.

Results:

As shown above in Table 2, the coatings without any abrasive particle and with ceramic microspheres as the abrasive particle performed the worst resulting in a visual evaluation of scratching of B4, which means these samples showed heavy scratching. The coatings using aluminum oxide as the abrasive particle had a visual evaluation of scratching of B3, which means these samples showed moderate scratching. The inventive coatings with diamond as the abrasive particle performed the best resulting in a visual evaluation of scratching of B2, which means these samples showed light scratching. In sum, the inventive coatings have the best results and were clearly better in scratch resistance as compared to even the aluminum oxide coatings.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

1. A composition comprising:
(a) a radiation curable coating composition, such as a floor coating composition; and
(b) a pre-mix including abrasion resistant particles and a dispersing agent.

2. The composition of claim 1, wherein said abrasion resistant particles comprise diamond.

3. The composition of claim 2, wherein said abrasion resistant particles comprise at least one other abrasion resistant particle having a Mohs hardness value of at least 6, such as aluminum oxide.

4. The composition of claim 3, wherein said other abrasion resistant particle is present relative to diamond in a weight ratio of about 1:1 to about 10:1.

5. The composition of claim 1, wherein said abrasion resistant particles are present in an amount of about 1% to about 15% by weight of the composition.

6. The composition of claim 1, further comprising a wax powder

7. The composition of claim 6, wherein said wax power is present in said pre-mix.

8. The composition of claim 6, wherein said wax powder comprises polytetrafluoroethylene.

9. The composition of claim 1, wherein said coating composition is UV curable.

10. The composition of claim 1, wherein said coating composition comprises an acrylate, (meth)acrylate, or combinations thereof.

11. A method for applying a coating to flooring in the field comprising:
(a) providing a radiation curable coating composition;
(b) providing a pre-mix including abrasion resistant particles and a dispersing agent;
(c) combining said coating composition and said pre-mix to provide an abrasion resistant coating composition; and
(d) applying said abrasion resistant coating composition to a flooring component.

12. The method of claim 11, wherein said flooring component is selected from a floor tile, a floor plank, an installed flooring system, or combinations thereof.

13. The method of claim 11, wherein said applying is conducted by rolling, spreading, spraying, or combinations thereof.

14. The method of claim 11 further comprising curing said abrasion resistant coating composition.
